(19) United States
(12) Patent Application Publication
(10) Pub. No.: US 2005/0162707 A1
(43) Pub. Date: Jul. 28, 2005

(54) Scanning apparatus and method for full page scans

(76) Inventors: Brian K. Owens, Lexington, KY (US); Donald N. Spitz, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 10/764,154

(22) Filed: Jan. 24, 2004

(51) Int. Cl. H04N 1/40

(52) U.S. Cl. 358/449; 358/494

(57) ABSTRACT

The present invention provides, an improved scanning apparatus and method for full-page scanning. The apparatus comprises a flat-bed scanner having a pattern disposed on a lower surface of the scanner housing. More specifically the pattern may be produced on a raised edge defining a platen aperture on a surface of the scanner housing. The pattern is recognized by the scanbar and processor so that the scanner can distinguish between a platen aperture edge and a document or image during a full-page scan. The present method comprises making a prescan to recognize and locate the platen aperture. Next, a primary scan is performed and scanned data is produced. During the primary scan, the scanbar may not scan the pattern. Alternatively, the scanbar may scan the pattern and subsequently remove the pattern from the scanned data. According to another method, the scanner may make a single scan collecting the pattern and the image. Subsequently, a processor may remove the pattern and, therefore the platen aperture edge from the scanned data.

### CROSS REFERENCES TO RELATED APPLICATIONS

The application is related to U.S. Patent Application Ser. No. ______ filed Jan. 9,2004, entitled “SCANNER AND METHOD FOR SCANNING AN IMAGE OR IMAGES and assigned to the assignee of the current application.

### STATEMENT REGARDING FEDERALLY SPONSORED RESEARCH OR DEVELOPMENT

None.

### REFERENCE TO SEQUENTIAL LISTING, ETC.

None.

### BACKGROUND

1. Field of the Invention

The present invention relates to an improved apparatus and method of full page scanning. More particularly, the present invention relates to an image recording apparatus having a flat-bed scanner including a pattern on a surface of a scanner housing so that a scanbar may recognize a housing edge.

2. Description of the Related Art

Scanners are used to scan a target image to create a scanned image which can be displayed on a computer monitor, which can be used by a computer program, which can be printed, which can be faxed, etc. Scanned data may be saved to memory or an magnetic or optical drive, or other memory device. Scanning devices may be packaged in a stand-alone housing or as part of a multi-function peripheral, including a printing component to perform scanning as well as standard copying functions.

Scanners typically include a housing aperture defined by an edge wherein a platen is located. An original document is positioned on the platen for scanning of the text or image by a scanbar. Depending on the positioning of the scanbar to the platen, the platen may be transparent where the scanbar is beneath the platen or may be solid where the scan bar is above the platen.

In a conventional scanning operation the scan bar starts out at the homing position at a homing reference. By having the scanbar be located at the scanbar homing reference before starting a scan, the scanner is able to establish an accurate position reference for the scanbar each time the scanbar moves from the scanbar homing reference as well as calibrating the sensor elements to a known white (or other color) surface and, optionally, to a known black surface before performing a prescan of the image. A prescan of the image is performed by then moving the scan bar along the major axis (typically, the length of the platen aperture area) in relation to or over the image over the complete platen aperture area. The scanner obtains information about the image from the prescan which the scanner uses for the subsequent image scan of the image. Prescan information of the image includes, without limitation, the size of the image (including the length of the image along the major axis), whether the image is text or graphics or a combination of both, and whether the image is monochrome or color. Such prescan information is used, without limitation, to automatically tune the image scan to obtain the best combination of scan speed, scan resolution, print resolution, shingling, filtering, and color tables for the particular image, as is known to those skilled in the art. After the prescan, the scanbar is returned to the scanbar homing reference to reestablish an accurate position reference for the scanbar. An image scan is performed by then moving the scanbar along the major axis in relation to or over the image. After the image scan, the scanbar is returned to the scanbar homing reference to reestablish an accurate position reference for the scanbar and to await the next image. Another conventional method omits the prescan.

When target images or documents are placed along the housing edge, the scanners often include a portion of at least one housing edge with the scanned data for various reasons. However, inclusion of a housing edge in the scan data is undesirable because an unsightly line or artifact is produced on the copy or included in the saved data. As a result, many prior art scanning devices arbitrarily delete some portion of the scanned data around the scanned edges in order to remove such a line. For instance, some scanning devices may scan an image and arbitrarily delete up to about 3 millimeters per edge to ensure that a housing edge is not included as part of the scanned image.

Arbitrary deletion of a portion of the scanned image does not cause problems under some circumstances. For example, when a text document is scanned deletion of portions of the edges may not generally degrade the quality of the scanned text since such documents typically have a blank border defined by a margin. In other words, no useful data is likely to be deleted. To the contrary, full page scans of images are becoming increasingly popular among peripheral users. If a borderless full page image is scanned, arbitrary deletion of some portion of data near the image edge may be undesirable. For instance, some images may include data along a border such as a telephone number, email address, or artist name, along an edge or border which may be deleted in order to ensure that a housing edge is not included in the scanned data. Alternatively for instance, a 4″×6″ photo may be scanned for enlargement to 8″×10″. If some data is deleted by the scanner to eliminate a housing edge, the scanned data must be over-enlarged to compensate for the deleted portions and still provide a full size 8″×10″ image for printing. Thus one can clearly understand that deletion of useful scanned data is undesirable.

Given the foregoing deficiencies, it will be appreciated that a scanning device is needed which recognizes a housing edge so that the edge may be removed from the scanned data and so that image data is not arbitrarily deleted.

### SUMMARY OF THE INVENTION

With regard to the foregoing, the present invention eliminates the oversights, difficulties, and disadvantages of the prior art by providing an improved apparatus and method of full page scanning.

An object of the present invention is to provide a flat-bed scanning device which detects an edge of a platen aperture.

An additional object of the present invention is to provide a pattern along a platen aperture edge on a surface, such as the undersurface, of a scanner housing in order to detect the platen aperture.

Another object of the present invention is to enable detection of an edge of the platen aperture by a scanbar movably housed within the scanner bed which recognizes the pattern positioned adjacent the platen aperture edge.

According to the invention, an improved scanning apparatus and method for full-page scanning is provided. The apparatus comprises a flat-bed scanner having a pattern produced on a surface of the scanner housing surrounding a platen aperture. More specifically the pattern may be produced on a raised edge defining a platen aperture on a surface of the housing. The pattern is recognized by the scanbar and image sensor so that the scanner can distinguish between a platen aperture edge and a document or image during a full-page scan.

The present method comprises making a prescan to recognize and locate a platen aperture. Next, a primary scan is performed and scanned data is produced. During the primary scan, the scanbar is inhibited from scanning the pattern. Alternatively, the scanbar may scan the pattern with the pattern data being subsequently removed from the scanned data. According to a second method, the scanner may make a single scan collecting the pattern and the image in the scanned data. Subsequently, a processor may remove the pattern and, therefore the platen aperture edge from the scanned data or the pattern may be removed manually by a user.

### BRIEF DESCRIPTION OF THE DRAWINGS

FIG. 1 is a perspective view of a multi-function peripheral of the present invention having a flat bed scanner;

FIG. 2 is a top view of a lower housing of the scanner device shown in FIG. 1 illustrating a scanbar mechanism;

FIG. 3 is an bottom view of an upper housing of the scanner device shown in FIG. 1 illustrating a platen aperture;

FIG. 4 is a top view of the upper housing of FIG. 3 of the present invention;

FIG. 5 is an illustration of exemplary patterns which may be utilized with the flat-bed scanner of FIG. 1;

FIG. 6 is an illustration of further exemplary patterns which may be utilized with the flat bed-scanner of FIG. 1;

FIG. 7 is a flowchart depicting an improved method of performing a full page scan by making a prescan; and,

FIG. 8 is a flowchart depicting an alternative method of performing a full page without making a prescan.

### DETAILED DESCRIPTION

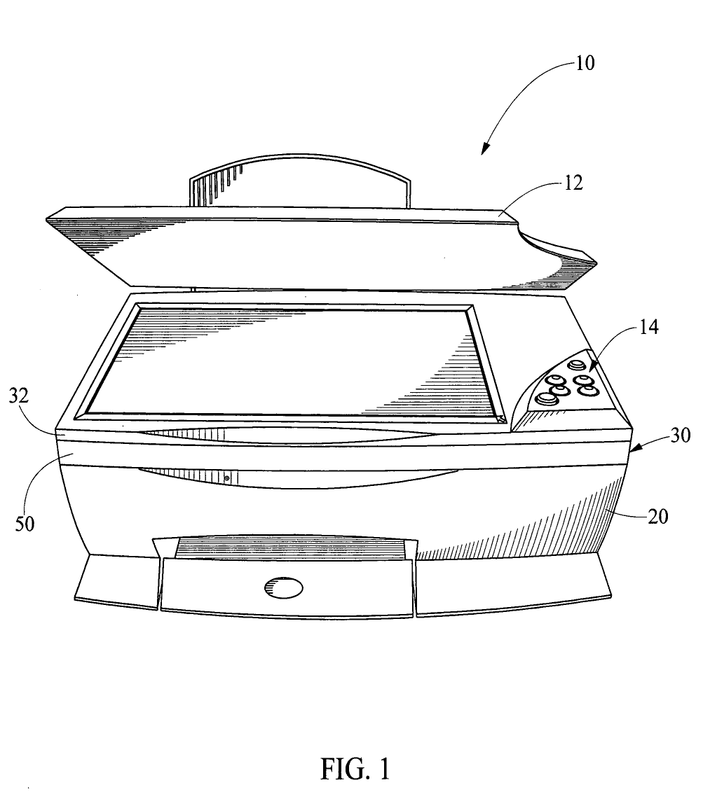

Referring now in detail to the drawings, wherein like numerals indicate like elements throughout the several views, there is shown in FIGS. 1 through 6 various aspects of an illustrative multi-function peripheral including a scanner. The scanner includes a scanning bed having an upper housing and a pattern located on a surface of the upper housing that is scannable by the scanbar of the scanner. The present invention provides an improved scanning apparatus and methods for full page scan wherein a pattern is disposed on a surface of a scanner housing about a platen aperture in order that a scanbar may detect the pattern and data representing the platen aperture edge may be deleted from the scanned data.

For purposes of this invention description the term minor axis is defined as the shorter dimension of a generally rectangular scanning bed and the term major axis is defined as the longer dimension of the generally rectangular scanning bed and is substantially perpendicular to the minor axis. The scanning direction is the direction of movement of the scanbar which according to this illustrative embodiment is parallel to the major axis. Further, use of the term image hereinafter is meant to include both photographs, graphics and drawings as well as text images. Full page scan is defined to mean a scan of an image wherein scanned data from the image is not removed or deleted in order to eliminate an edge of the platen aperture or other artifact introduced because of the abutment of the image against the edges of the platen aperture in the scanner.

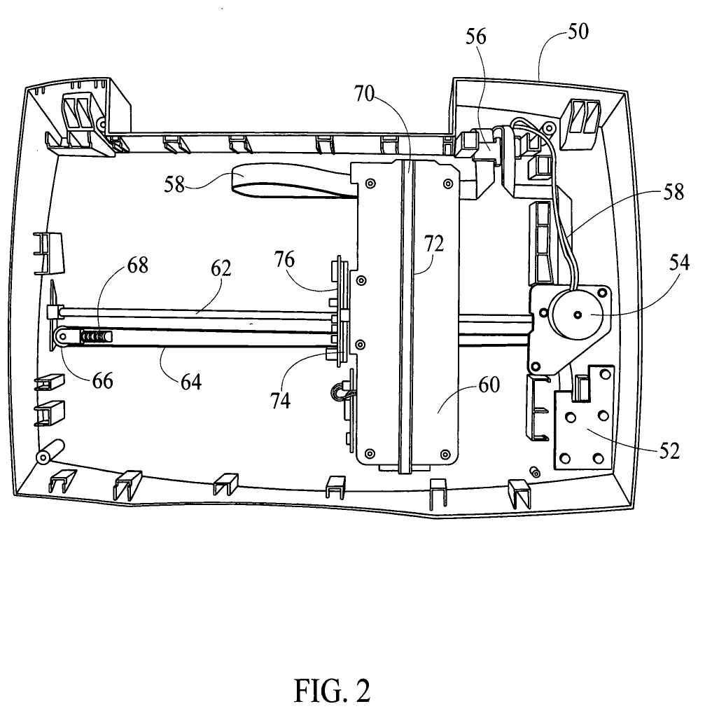

Referring initially to FIG. 1, a multi-function peripheral 10 is depicted having both a printing component 20 and a scanning component 30 such as a flat-bed scanner. The multi-function peripheral 10 includes a control interface 14 having at least one button for operating the flat-bed scanner. As best seen in FIGS. 2-4, the scanning component or scanner bed 30 which may be formed of an upper housing portion 32 and a lower housing portion 50. The scanner bed 30 is generally rectangular in shape having longer parallel edges across the front and rear of the peripheral device 10 and shorter parallel edges across the side surfaces of the device 10. This edge may also be described as a single edge defining the periphery of the platen aperture 44. For a rectangular opening, the edge may be described as having one or more pairs of opposed spaced apart segments that are substantially parallel to one another. It should be understood that although the multi-function peripheral is shown and described throughout, it is well within the scope of the present disclosure to apply the instant invention to a stand-alone flat-bed scanner.

Referring now to FIGS. 1, 3 and 4, the upper housing portion 32 may vary in shape and according to the present embodiment is generally rectangular. A substantially U-shaped portion may be removed from the rear of the device allowing for positioning of a paper feed tray. In a front corner of the upper housing portion 32 is the control interface 14 for inputting functions to the scanning component 30 and, according to the illustrative embodiment, the printing component 20. The scanning component 30 as shown includes a hinged lid 12 extending from an upper edge of the bed 30 wherein the lid 12 may be closed during scanning functions or opened, as shown in FIG. 1, to reveal a scanning platen 42 where upon a document or image may be placed for scanning.

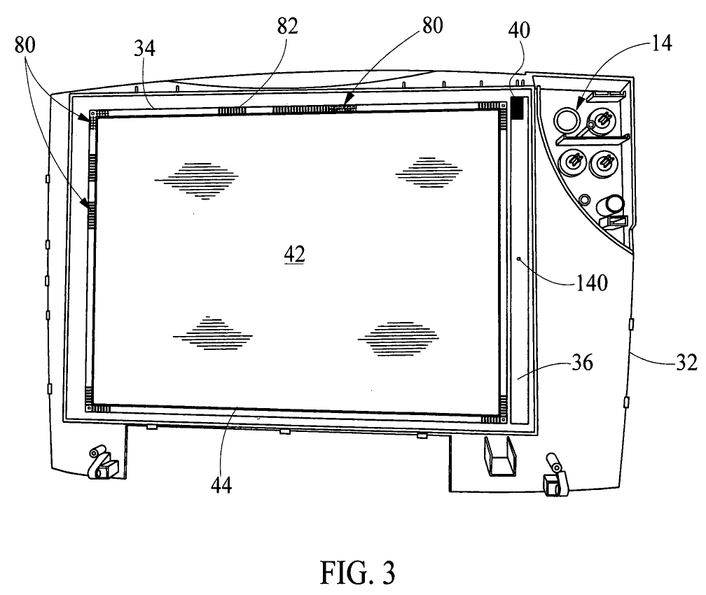

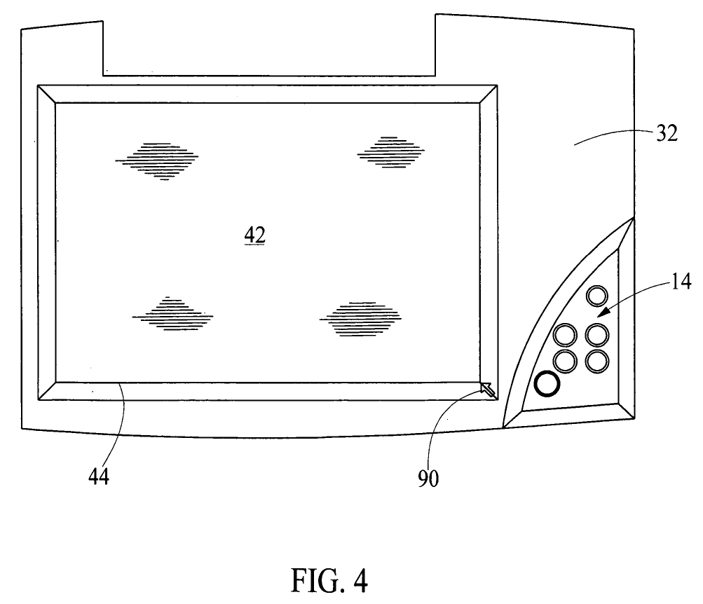

Referring still to FIGS. 1, 3 and 4, centrally located in the upper housing portion 32 is the platen opening or aperture 44 which is defined by an edge, preferably a raised edge 34, as shown in FIG. 3. The platen aperture 44 may vary in shape and, as presently depicted, may be substantially rectangular in shape with a major axis and a minor axis. As previously indicated the major axis is defined as the longer dimension defining the rectangular platen 42 and platen aperture 44 and is also the direction of movement of a scanbar 60. The minor axis is defined as the smaller dimension defining the platen 42 and platen aperture 44. Within the platen aperture 44 is a platen 42 which may be formed of a transparent material including glass or some comparable material whereupon a document or image is placed for scanning. The raised edge or lip 34 depends from the upper housing 50, as shown in FIG. 3, and provides for a flush fit between the upper surface of the platen 42 and the lower surface of the housing portion 32. As depicted in FIG. 4, an upper surface of the upper housing portion 32 may include a justification mark 90 for visually indicating to a user where to align a target image for scanning. The justification mark 90 is shown in a lower right hand corner of the platen aperture 44 however, the location of the justification mark 90 may vary.

Referring now to FIGS. 2 and 3, a calibration strip 36 extends along a minor axis edge of the platen aperture 44. The calibration strip 36 may be a white strip of material which an image sensor 74 within the scanbar 60 utilizes to calibrate before scanning. The calibration strip 36 is depicted as being substantially rectangular in shape extending the length of the minor axis of the platen aperture 44.

Also shown on the calibration strip 36 are origin marks 40, 140. Although two origin marks 40, 140 are shown, only one mark is necessary and in either case, the second mark is merely an illustrative alternative. The origin marks 40, 140 are utilized to orient the scanbar 60 to its home position. As seen in FIGS. 3 and 4, the origin mark 40 is positioned opposite the justification mark 90 where the user is visually indicated to position a document or image. When the scanbar 60 reads the origin mark 40, the processor 56 recognizes that the scanbar 60 is properly positioned in a home position and may begin scanning. Thus, the origin mark 40 is positioned at the same corner of the platen aperture 44 as the justification mark 90. Alternatively, origin mark 140 may be positioned along a side of the platen aperture 44 rather than at a corner. In this case the origin mark 140 may be in the middle of the calibration strip 36 rather than a corner wherein the home position may be the center of the minor axis of the platen aperture 44.

Referring now to FIG. 2, a top view of the lower housing portion 50 is shown depicting a plurality of scanning components which define a motion control system for the scanbar 60. Starting at a lower right hand side of the lower housing portion 50 a control input board 52 is shown. The control input board is directly beneath and operably communicating with the control interface 14 shown in FIGS. 1 and 3. Adjacent the control input board 52 is a motor 54 for motion control of the scanbar 60. The motor 60 may for example be a DC motor or a stepper motor and is operably connected to a drive 64. According to the present embodiment the drive 64 is a belt drive system including a tensioning pulley 66 opposite the motor 54 within the lower housing portion 50. The pulley 66 may have a biasing spring 68 in contact therewith in order to maintain a tensioning force on the belt drive 64. Alternatively however, the present system may utilize various drive systems including but not limited to gear drives, such as worm drives, or various other drive components.

A scanner processor 56 is shown electrically coupled to the motor 54 and by flat flexible cable or ribbon cable 58 to the scanbar 60. The processor 56 controls signals which cause the motor 54 and drive belt 64 to operate and move the scanbar 60. As the motion control system urges the scanbar 60 to move, at least one scanbar guide rod 62 directs movement of the scanbar 60 through the direction of the major axis of the platen 42 and platen aperture 44. That is, the scanbar guide rod 62 extends in a direction parallel to the scanning direction.

Referring still to FIG. 2, the scanbar 60 is shown slidably connected to the scanbar guide rod 62. Typically, the scanbar 60 may be of either a charge coupled device (CCD) type or a contactimage sensor type. The CCD type uses a CCD array 74 mounted on circuit board 76. The CCD array 74 is a collection of tiny, light-sensitive diodes, which convert photons into electrons. These diodes are called photosites the brighter the light that hits a single photosite, the greater the electrical charge that will accumulate at that site. The image of the document that is scanned using a light source 70, such as a fluorescent bulb, reaches the CCD array through a series of mirrors, filters and lenses. The exact configuration of these components will depend on the model of scanner. Some CCD scan bars use a three pass scanning method. Each pass uses a different color filter (red, green or blue) between the lens and CCD array. After the three passes are completed, the scanner software assembles the three filtered images into a single full-color image. Most CCD scanners use the single pass method. The lens splits the image into three smaller versions of the original. Each smaller version passes through a color filter (either red, green or blue) onto a discrete section of the CCD array. The scanner software combines the data from the three parts of the CCD array into a single full-color image.

In general, for inexpensive flatbed scanners contact image sensors (CIS) are used in the scanbar 60. A CIS array replaces the CCD array 74, mirrors, filters, lamp and lens with an array of red, green and blue light emitting diodes (LEDs) and a corresponding array of phototransistors. The image sensor array consisting of 600, 1200, 2400 or 4800 LEDs and phototransistors per inch (depending on resolution) spans the width of the scan area and is placed very close to the platen 42 upon which rests the image to be scanned. When the image is scanned, the LEDs combine to provide a white light source. The illuminated image is then captured by the row of sensors. Color scanning is done by illuminating each color type of LED separately and then combining the three scans.

In order to scan an image, the scanbar 60 has at least one dimension being longer than one dimension of the platen 42. According to the instant embodiment, the scanbar 60 has a length which is longer than the minor axis dimension of the platen 42. Further, the scanbar opening 72, wherein an image is received, is longer than the minor axis dimension of the platen 42. Thus a full page scan may be performed by urging the scanbar 60 to move from one end of the platen 42 to a second end of the platen 42 through the major axis or in the scanning direction and generating scan data line by line as the scanbar 60 moves along the major axis. However, since the scanbar 60 and scanbar opening 72 are longer than the minor axis dimension of the platen 42, the image sensor 74 will capture data representing at least a portion of the platen aperture edge 44 along the major axis. In addition, in order to perform a full page scan, the image sensor 74 may also capture data representing the platen aperture edges along the minor axis at a first scan end and a second scan end. Scanning data which represents a platen aperture edge results in lines on any copies of the scanned image which reduces scan quality and is undesirable. As previously described, arbitrary deletion of portions of a full page scan may result in deletion of edge data which is also undesirable.

As previously indicated, the present invention overcomes the problem of capturing data which represents the platen aperture 44. In order to overcome this problem, the instant invention utilizes a pattern 80 which extends along an edge of the platen aperture 44, as seen in FIG. 3. The present invention effectively inserts a known pattern 80 into a scanned image and, according to one embodiment, the processor 56 subsequently removes the pattern 80 from the scanned data before exporting the scanned data to, for instance, a host PC or before printing the image. According to a second embodiment the scanned pattern 80 may be included in the scanned data and removed by a user of the host PC. The multifunction peripheral 10 may also include the means necessary to remove the pattern 80 from the scanned data.

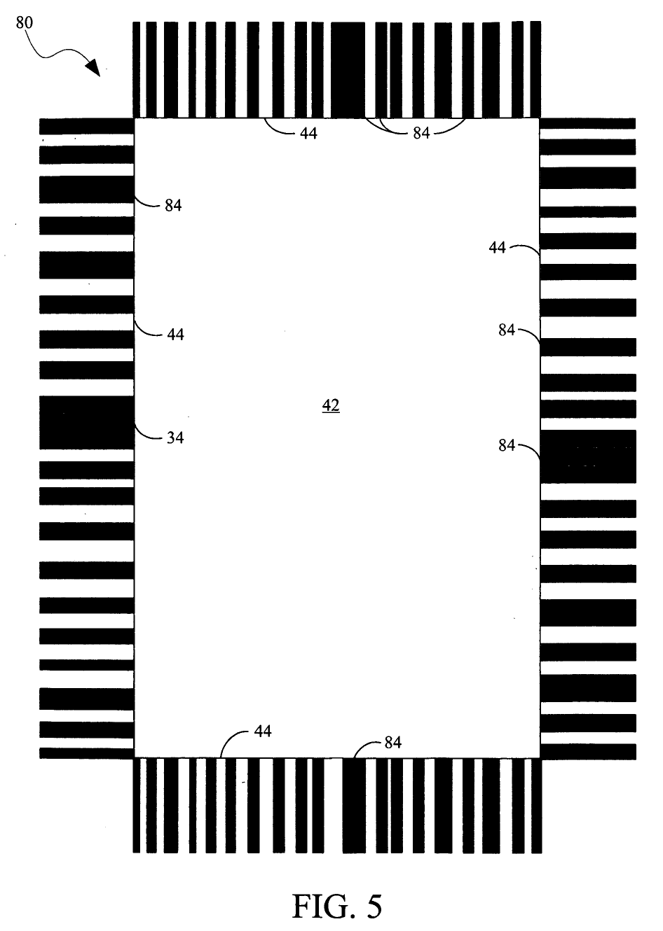

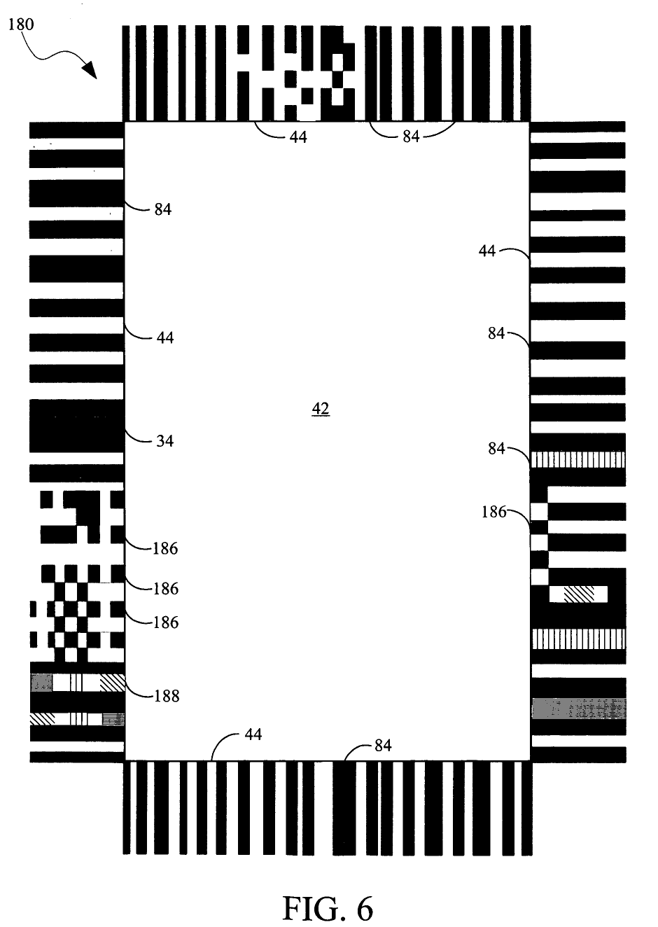

As shown in FIG. 3, one illustrative embodiment of the present invention utilizes a pattern 80 positioned on a lower surface of the raised edge or lip 34. For purpose of simplicity, the pattern 80 is not shown extending along the entire length of each edge 34 of platen aperture 44 but is intended to do so as shown in FIGS. 5 and 6. Referring still to FIG. 3, the pattern 80 may be molded or the pattern 80 may be painted or screen printed on the raised edge 34. According to a first embodiment, the pattern 80 is molded into the raised edge 34 defining a plurality of ridges 82 which extend along the raised edge 34. The ridges 82 may define some preselected shape including bars, dots, or other pattern defining shapes. The image sensor 74 may read the ridges 82 when the scanbar 60 passes over the ridges 82. In a first alternative embodiment, the ridges 82 may be painted or printed, for instance screen-printed, with some color which contrasts the color of the molded edge 34. With a contrasting color, the image sensor 74 will be able to easily distinguish the pattern 80 from the plastic there beneath. For example, if the molded plastic has a color of black, then the ridges may be painted or printed white or vice-versa. With the ridges 82 formed, a paint or ink source may be rolled or pad printed across the raised edge 34 and may contact only the upper surface of the ridges 82 because of their height difference with the edge 34 aiding in providing the aforementioned contrast. According to yet a second alternative, the raised edge 34 may be screen-printed to form the pattern 80 without the molded ridges 82. The screen-printing preferably is a contrasting color to the plastic defining the raised edge 34 so that the pattern 80 may be distinguished by the image sensor 74 within the scanbar 60. In any of the embodiments, the pattern 80 is recognized by the image sensor 74 and processor 56 such that the scanbar 60 and processor 56 can distinguish the platen aperture 44, defined by the raised edge 34 and pattern 80, from the scanned image adjacent the platen aperture 44.

The positioning of the pattern 80, 180 is shown on a under surface of the upper housing portion 32. Where the scanbar 60 is positioned above the platen 42, for example if the scanbar is in the lid 12, the pattern 80, 180 would be positioned on the upper surface of the housing portion adjacent platen opening 44. Irrespective of orientation that is dependent on the scanner design, the pattern 80, 180 needs to be viewable or scannable by the scanbar 60.

Referring now to FIGS. 5 and 6, alternative patterns are shown. FIG. 5 depicts a plurality of bars 84 which may be molded and/or screen printed on the raised edge 34. The bars 84 may be some preselected pattern which the processor can easily distinguish from a scanned image thereby revealing the edge 34 of the platen aperture 44. The bars 84 may vary in thickness and length but should be justified adjacent to the edge of the platen aperture 44 so that the processor 56 may distinguish between the scanned image and the raised edge 34. The bars 84 are a dark color which contrasts with a lighter background of the raised edge 34, however, if a darker background color is used then the bars 84 may be screen printed with a lighter color. Preferably, the pattern 80 is positioned as abutting the edge of the platen aperture 44, however, the pattern 80 may also be spaced apart from the edge of the platen aperture 44 a predefined distance.

As shown in FIG. 6, an alternative pattern 180 may also comprise a plurality of dots or small squares 186 and bars 84. The dots 186 may form a checkered pattern or some other preselected design. In addition, the dots 186 may include a plurality of bars 84 interposed between or adjacent to the dot patterns 186. The pattern 180 may include a plurality of colors 188 rather than one contrasting color. It should be understood by one of ordinary skill in the art that various shapes, combinations, and alternatives of the patterns 80, 180 may be utilized and are considered to be within the scope of this invention, so long as the pattern is recognizable by the scanner. Semicircles, crescent shapes may also be used in the pattern. The shape types used in the pattern are not critical so long as some edge in the shapes chosen for the pattern is adjacent to the platen aperture edge.

In the present embodiment, the pattern 80, 180 is positioned along at least two edges of the platen aperture 44. Since the present embodiment utilizes a justification mark 90 within at least one corner of the platen aperture 44, it is anticipated that the scanned image or document will be justified against at least two edges of the platen aperture 44 or at least two portions of the edge of the platen aperture 44. Thus, at least two edges may be scanned and included into the scanned data as part of the original. In the event that a scanned document or image fills the platen aperture, it is well within the scope of the instant invention that the scanned document will be adjacent all four edges 34 of the platen aperture 44. In that event, it is preferable that the platen aperture 44 have the pattern 80, 180 extending along all four sides or coextensive with the entire length of the edge of the platen aperture 44. In the event that a document or image is only meant for justification along one edge, such as when origin mark 140 is utilized, then the pattern 80, 180 may be used along the justification edge having the mark 140.

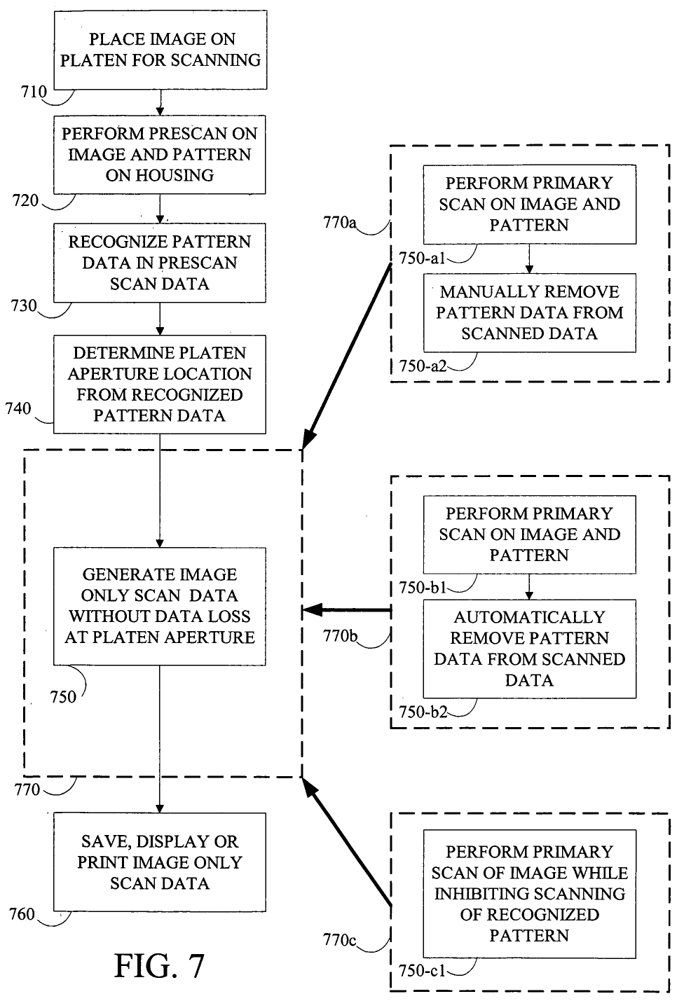

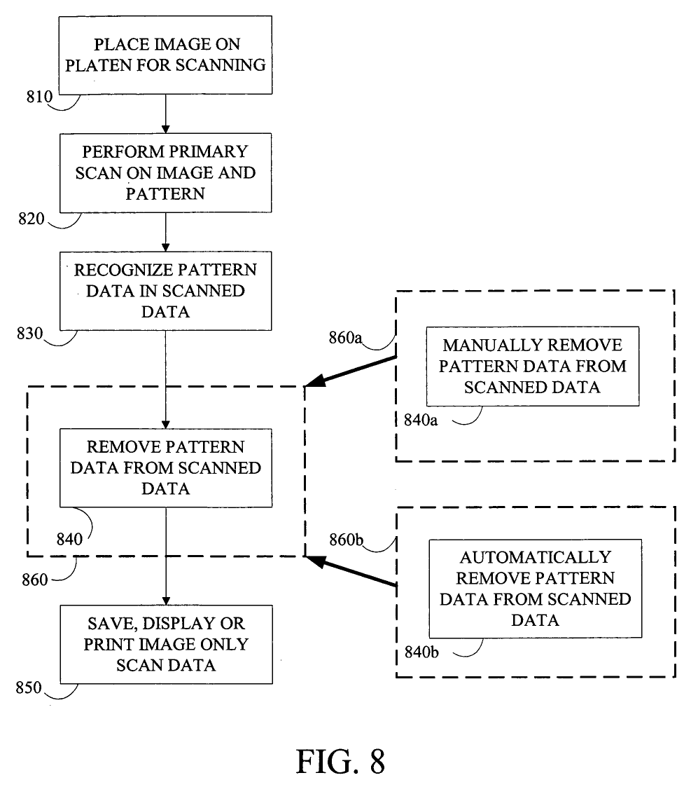

In operation, two methods may be utilized to perform an improved full page scan as shown in FIGS. 7 and 8. An image or document is placed on the platen 42 for scanning with the image facing the scanbar 60 at block 710. Next a prescan or a first scan motion is performed wherein the image is scanned along with the pattern on the scanner at block 720, the data pattern is recognized in the scanned data at block 730 and the platen aperture 44 location is determined as well in block 740. The prescan may be done at a lower resolution than the primary scan of the image. At block 750, shown within the dashed rectangle 770, image only data is produced without data loss at the platen aperture location. At block 760 the image only scanned data is saved, displayed or is used to print the image.

The generalized function performed at block 750 is shown within the dashed rectangle 770 as this function may be accomplished in many ways, three examples of which are shown in dashed rectangles 770a, 770b and 770c. As shown in dashed rectangle 770a, at block 750-a1 a primary scan of the image and pattern is performed. At block 750-a2 the pattern data is manually removed from the scanned data such as by a user using a computer and an image editor. As shown in dashed rectangle 770b, at block 750-b1 a primary scan of the image and pattern is performed. At block 750-b2 the pattern data is automatically removed for the scanned data such as by the processor in the multifunction device or by an attached computer. As shown in dashed rectangle 770c, at block 750-c1 a primary scan of the image is performed while scanning of the recognized pattern is inhibited.

According to a second method, at block 810 an image is placed on the platen for scanning. At block 820 a primary scan of the image and pattern is performed producing scanned image data. At block 830, the pattern data in the scanned data is found or recognized. At block 840 the pattern data is removed. At block 850 the image only scanned data is saved, displayed or is used to print the image.

The generalized function performed at block 840 is shown within the dashed rectangle 860 as this function may be accomplished in many ways, two examples of which are shown in dashed rectangles 860a, and 860b. As shown in dashed rectangle 860a, at block 840a the pattern data is manually removed from the scanned data such as by a user using a computer and an image editor. As shown in dashed rectangle 860b, at block 840b the pattern data is automatically removed from the scanned data such as by the processor in the multifunction device or by an attached computer.

It is apparent that variations may be made to the improved scanning apparatus and methods for full-page scan of the present invention in regards to specific design elements thereof. Such variations however are deemed to fall within the teachings of the present invention as generally modifications may be made to placement of the particular structure described herein while falling within the general teachings hereof.

1. An improved scanning apparatus, comprising:
a flat-bed scanner having a housing, scanbar and a transparent platen for images to be scanned;
said housing receiving said transparent platen; and,
said housing having a pattern adjacent a portion of said platen with said platen and said pattern being scannable by said scanbar.

2. The apparatus of claim 1 further comprising said housing having an aperture for receiving said platen with said pattern being positioned on a portion of an edge of said aperture adjacent said platen.

3. The apparatus of claim 2 further comprising said pattern extending along two edges portions of said platen aperture.

4. The apparatus of claim 3 further comprising said two edges of said platen aperture being substantially perpendicular to one another.

5. The apparatus of claim 2 further comprising said pattern being disposed along the entirety of the edge portion of said platen aperture.

6. The apparatus of claim I further comprising said pattern being defined by a plurality of preselected shapes.

7. The apparatus of claim 6 further comprising said shapes being selected from a group consisting of bars, rings, semicircles, crescents, dots, rectangles, and combinations of two or more of the foregoing.

8. The apparatus of claim 6 further comprising said shapes being of varying dimensions.

9. The apparatus of claim 6 further comprising said bars being of equal thickness.

10. The apparatus of claim 9 further comprising said bars being of varying length.

11. The apparatus of claim 1 further comprising said pattern being a single color contrasting with said housing color.

12. The apparatus of claim 1 further comprising said pattern having shapes of at least two colors.

13. The apparatus of claim 1 further comprising said pattern being a plurality of dots.

14. The apparatus of claim 1 further comprising said pattern having a plurality of dots defining a checkerboard pattern of at least a first color and a second color.

15. The apparatus of claim 13 further comprising said plurality of dots varying in size.

16. The apparatus of claim 13 further comprising said plurality of dots defining a preselected shape.

17. The apparatus of claim 13 further comprising said plurality of dots being multi-colored.

18. The apparatus of claim 1 further comprising said pattern including a bar and a dot.

19. The apparatus of claim 19 further comprising at least one of said bar and said dot being a second color.

20. The apparatus of claim 1 further comprising said pattern being formed on said housing by one of the following group consisting of screen-printing, pad painting, painting, printing, molding, pre-printed adhesive strips, or combinations of two or more of foregoing.

21. An improved scanning apparatus, comprising:
a multi-function peripheral having at least a scanner having a scanbar;
said scanner having an upper housing portion including a platen aperture therein;
said upper housing portion having an undersurface comprising a pattern; and
said pattern extending along each edge of said platen aperture.

22. The apparatus of claim 22 further comprising said housing having a raised edge defining said platen aperture.

23. The apparatus of claim 23 further comprising said pattern being disposed on said raised edge and scannable by said scanbar.

24. The apparatus of claim 23 further comprising said raised edge having a plurality of ridges scannable by said scanbar.

25. The apparatus of claim 25, further comprising a screen print on a top ridge surface of said molded ridges.

26. The apparatus of claim 25 further comprising said molded ridges defining said pattern.

27. An improved scanning apparatus, comprising:
a scanner having a scanbar and an upper housing portion having a platen aperture therein;
said scanner upper housing portion having a pattern along at least two edges of said platen aperture for optical recognition of said platen aperture edge by said scanbar.

28. The apparatus of claim 28 further comprising said at least two edges being perpendicular to one another.

29. The apparatus of claim 29, further comprising said at least two edges defining a home position for said scanbar and said platen aperture having a corresponding justification corner.

30. A method of producing a full-page scan of an image in a scanner, comprising:
placing the image within a platen aperture of the scanner on the scanner;
performing a prescan of said image and a pattern on said scanner;
recognizing said pattern in prescan scan data;
determining the platen aperture location by recognition of said pattern;
producing image only scan data without data loss at said platen aperture location.

31. The method of claim 31 wherein producing image only scan data further comprises performing a primary scan on said image and said pattern, and automatically removing said recognized. pattern data from said scanned data of said primary scan.

32. The method of claim 31 wherein producing image only scan data further comprises performing a primary scan on said image and said pattern, and manually removing said recognized pattern data from said scanned data of said primary scan.

33. The method of claim 31 wherein producing image only scan data further comprises performing a primary scan of said image while inhibiting scanning of said recognized pattern during said primary scan.

34. A method of producing a full page scan of an image in a scanner, comprising:
placing the image within a platen aperture of said scanner
scanning said image and a pattern on said scanner; and,
removing said pattern data from scanned data of said image and pattern.

35. The method of claim 35, further comprising automatically removing said pattern data from said scanned data.

36. The method of claim 35, further comprising manually removing said pattern data from said scanned data.

37. A method of producing a full-page scan of an image in a scanner, comprising:
placing the image on a platen aperture of said scanner performing a prescan of the image and a pattern on said housing of said scanner;
recognizing said pattern data and locating from said pattern data at least one platen aperture edge;
performing a primary scan of said image and said pattern; and
removing said pattern data from a scanned data produced during said primary scan.

38. The method of claim 38 wherein said pattern is located adjacent one edge of said platen aperture.

39. The method of claim 38 wherein said pattern is located adjacent to and coextensive with one edge of said platen aperture.
